(19) United States
(12) Patent Application Publication
(10) Pub. No.: US 2012/0036539 A1
(43) Pub. Date: Feb. 9, 2012

(54) ELECTRONIC DEVICE AND METHOD FOR SEARCHING PRODUCT INFORMATION IN TV PROGRAMS WITH PRODUCT PLACEMENTS

(75) Inventors: CHUNG-I LEE, Tu-Cheng (TW); CHIEN-FA YEH, Tu-Cheng (TW); SHAN-CHUAN JENG, Tu-Cheng (TW); CHENG-FENG TSAI, Tu-Cheng (TW); TSUNG-HSIN YEN, Tu-Cheng (TW); YU-FENG CHIEN, Tu-Cheng (TW); HO-I SUN, Tu-Cheng (TW)

(73) Assignee: HON HAI PRECISION INDUSTRY CO., LTD., Tu-Cheng (TW)

(21) Appl. No.: 13/097,071

(22) Filed: Apr. 29, 2011

(30) Foreign Application Priority Data
Aug. 9, 2010 (TW) 99126403

(51) Int. Cl. H04N 5/445

(52) U.S. Cl. 725/60

(57) ABSTRACT

A method searches product information in TV programs with product placements using an electronic device. The electronic device encloses presented products of the TV program in a graphic box, and defines keywords related to the presented products. During the TV program broadcasts, the electronic device receives a selection operation on a product displayed on a display device, and uses a search engine to search for related information of the selected product according to keywords. The searched information is displayed on the display device for users to browse.

### BACKGROUND

1. Technical Field

Embodiments of the present disclosure generally relate to advertisement displaying devices and methods, particularly to an electronic device and method for searching product information in TV programs with product placements.

2. Description of Related Art

Product placement is increasingly becoming a popular form of advertising in today's media environment, especially with the growing use of digital recording devices such as TIVO and DVR that allow viewers to skip commercials. While there are numerous advantages to this marketing strategy, one major disadvantage is that the viewers have no concrete information on what the product is or even where to purchase it. This lack of information contributes the lack of sales growth often associated with effective advertising.

### BRIEF DESCRIPTION OF THE DRAWINGS

FIG. 1 is a block diagram of one embodiment of an electronic device including an information searching unit.

FIG. 2 is a block diagram of one embodiment of function modules of the information searching unit of FIG. 1.

FIG. 3 is a flowchart illustrating one embodiment of a method for searching product information in TV programs with product placements.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

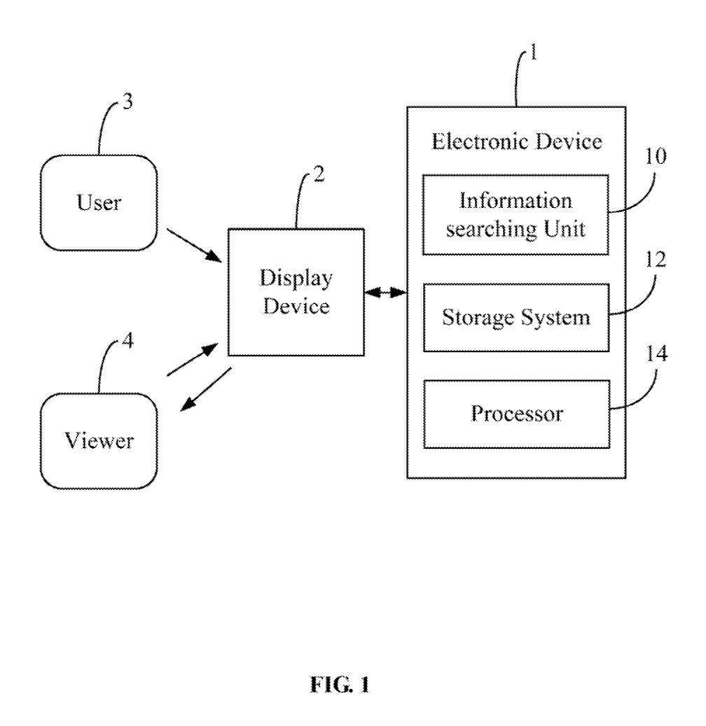

FIG. 1 is a block diagram of one embodiment of an electronic device 1 including an information searching unit 10. In the embodiment, functions of the information searching unit 10 are implemented by the electronic device 1. The information searching unit 10 can search related information of products presented in a TV program from networks, and display the searched information on a display device 2 that is electronically connected to the electronic device 1 via a wired or wireless connection. In one embodiment, the products may be cars, watches, or clothes. The searched information of the products may include web page and/or a website address. The TV program may be a movie, a TV series, or any other entertainment show.

In one embodiment, the electronic device 1 may be a computer, a TV, a portable electronic device, or any other electronic device that includes a storage system 12 and at least one processor 14.

The information searching unit 10 is configured to receive keywords of products that may be presented on the TV program, and use a search engine to search for related information of the products from a user 3. When a viewer 4 selects a product displayed on the TV program, the information searching unit 10 can load the keyword of the selected product in the search engine to search related information of the selected product, and displays the searched information on the display device 2. The search engine can be predetermined as will be shown below.

The display device 2 is used for receiving a selection operation of the product from the viewer 4, and displaying the searched information of the selected product. In the embodiment, the display device 2 is a touch-sensitive display or a 3D display, and can receive an input operation of the viewer 4 using a finger or a stylus pen. For example, if the electronic device 1 is a TV, the viewer 4 can use a remote control to operate (i.e., select a product) the electronic device 1.

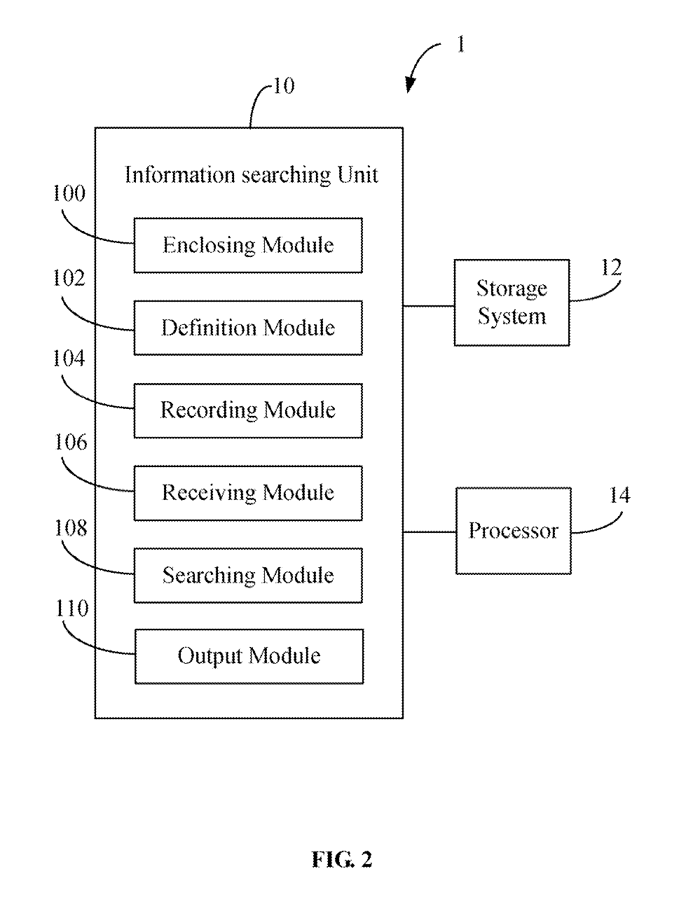

FIG. 2 is a block diagram of one embodiment of function modules of the information searching unit 10 of FIG. 1. In one embodiment, the information searching unit 10 includes an enclosing module 100, a definition module 102, a recording module 104, a receiving module 106, a searching module 108, and an output module 110. Each of the modules 100-110 may be a software program including one or more computerized instructions that are stored in the storage system 12 and executed by the processor 14.

In one embodiment, the storage system 12 may be a magnetic or an optical storage system, such as a hard disk drive, an optical drive, or a tape drive.

Before the display device 2 broadcasts a TV program, the enclosing module 100 encloses presented products of the TV program in a graphic box. The graphic box can be a rectangle, a circle, lines, or a box drawn by the user 3. In the embodiment, the definition module 102 defines a size of the graphic box according to a displayed size of the product on the display device 2.

The definition module 102 further defines the keywords of the products. For example, the definition module 102 defines “007watch” as a keyword of a watch that is worn by a man in a TV series.

The recording module 104 records the keywords in an image file that is compatible with the TV program. In one embodiment, the image file may be in a MPEG-2, MPEG-4, or an AVC format.

When the display device 2 displays the TV program, the receiving module 106 receives a selection operation of a product from the viewer 4. For example, if the display device 2 is a touch-sensitive display, the viewer 4 may use a finger to select the product presented on the TV program, and then the receiving module 106 receives the selection operation.

The searching module 108 loads the keywords of the selected product in a search engine, and searches related information of the selected product from networks using the search engine. In one embodiment, the search engine may be predetermined such as use of an Internet search engine or other searching tools, and the related information may be web pages, and/or website addresses. As mentioned above, the search engine may be predetermine or in other embodiments, be user-defined.

The output module 110 displays the searched information of the selected product on the display device 2, so the viewer 4 can browse the searched information from the display device 2.

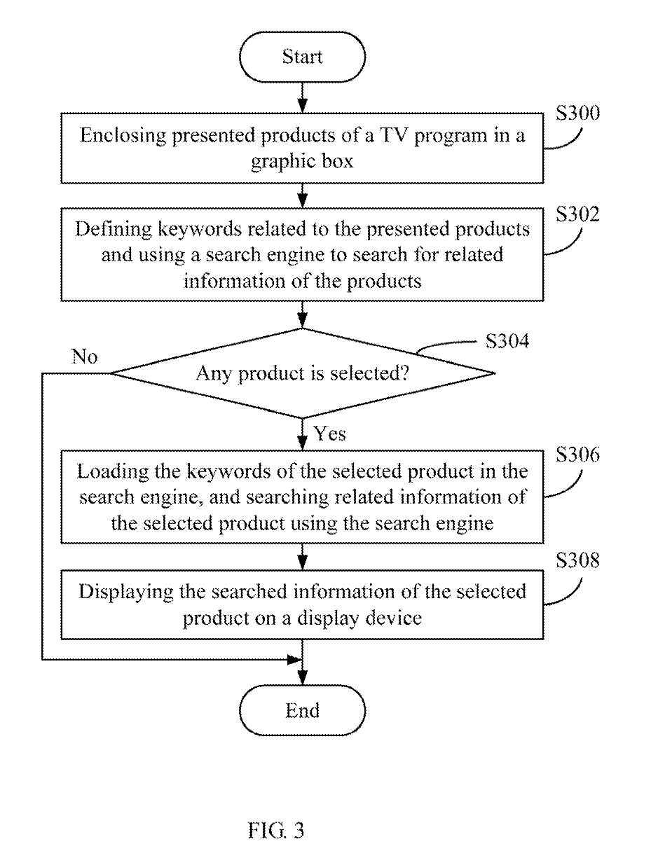

FIG. 3 is a flowchart illustrating one embodiment of a method for searching product information in TV programs with product placements. Depending on the embodiment, additional blocks may be added, others removed, and the ordering of the blocks may be changed.

In block S300, the enclosing module 100 encloses presented products of the TV program in a graphic box. In the embodiment, the TV program may be a movie, a TV series, or any other entertainment shown. The graphic box can be a rectangle, a circle, lines, or a box drawn by the user 3. In the embodiment, a size of the graphic box can be defined according to a displayed size of the product on the display device 2.

In block S302, the definition module 102 defines a keyword related to each product. Also, the recording module 104 records the keyword of each product in an image file that is compatible with the TV program. The image file may be in a MPEG-2, MPEG-4, or an AVC format.

When the display device 2 displays the TV program, in block S304, the receiving module 106 determines whether any product presented on the TV program has been selected by the viewer 4. In one example, the viewer 4 may touch the display device 2 with a finger to select the product. If any product has been selected, block S306 is implemented. If no product is selected, the flow ends.

In block S306, the searching module 108 loads the keywords of the selected product in a search engine, and searches related information of the selected product from networks using the search engine. In one embodiment, the related information of the selected product may be web pages and/or website addresses.

In block S308, the output module 110 displays the searched information of the selected product on the display device 2, so that the viewer 4 can browse the searched information of the selected product from the display device 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for searching product information in TV programs with product placements using an electronic device, the method comprising:
enclosing presented products of a TV program in a graphic box;
defining keywords related to the presented products;
selecting a product from the presented products displayed on a display device electronically connected to the electronic device during the TV program broadcasts;
searching related information of the selected product according to keywords of the selected product using a search engine; and
displaying the searched information of the selected product on the display device.

2. The method as described in claim 1, further comprising:
defining a size of the graphic box according to a displayed size of a corresponding product on the display device.

3. The method as described in claim 1, further comprising:
recording the keywords of the presented products in an image file that is compatible with the TV program.

4. The method as described in claim 3, wherein the image file is in a MPEG-2, MPEG-4, or an AVC format.

5. The method as described in claim 1, wherein the TV program is a movie, a TV series, or an entertainment show.

6. The method as described in claim 1, wherein the graphic box is a rectangle, a circle, lines, or a box that is drawn by a user.

7. An electronic device, comprising:
at least one processor;
a storage system; and
one or more modules that are stored in the storage system and executed by the at least one processor, the one or more modules comprising instructions:
to enclose presented products of a TV program in a graphic box;
to define keywords related to the presented products;
to select a product from the presented products displayed on a display device electronically connected to the electronic device during the TV program broadcasts;
to search related information of the selected product according to keywords of the selected product using a search engine; and
to display the searched information of the selected product on the display device.

8. The electronic device as described in claim 7, wherein the instructions further define a size of the graphic box according to a displayed size of a corresponding product on the display device.

9. The electronic device as described in claim 7, wherein the keywords related to the presented products are recorded in an image file that is compatible with the TV program.

10. The electronic device as described in claim 9, wherein the image file is in a MPEG-2, MPEG-4, or an AVC format.

11. The electronic device as described in claim 7, wherein the TV program is a movie, a TV series, or an entertainment shown.

12. The electronic device as described in claim 7, wherein the graphic box is a rectangle, a circle, lines, or a box that is drawn by a user.

13. A non-transitory storage medium having stored thereon instructions that, when executed by a processor of an electronic device, causes the processor to perform a method for searching product information in TV programs with product placements, the method comprising:
enclosing presented products of a TV program in a graphic box;
defining keywords related to the presented products;
selecting a product from the presented products displayed on a display device electronically connected to the electronic device during the TV program broadcasts;
searching related information of the selected product according to keywords of the selected product using a search engine; and
displaying the searched information of the selected product on the display device.

14. The non-transitory storage medium as described in claim 13, wherein the method further comprises:
defining a size of the graphic box according to a displayed size of a corresponding product on the display device.

15. The non-transitory storage medium as described in claim 13, wherein the method further comprises:
recording the keywords of the presented products in an image file that is compatible with the TV program.

16. The non-transitory storage medium as described in claim 15, wherein the image file is in a MPEG-2, MPEG-4, or an AVC format.

17. The non-transitory storage medium as described in claim 13, wherein the TV program is a movie, a TV series, or an entertainment shown.
